(19) United States
(12) Patent Application Publication
(10) Pub. No.: US 2008/0279087 A1
(43) Pub. Date: Nov. 13, 2008

(54) Method for Multi-Level Recording and Reproduction of Information and Apparatus Therefor

(75) Inventor: Masakuni Yamamoto, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/577,558

(22) PCT Filed: Jun. 1, 2005
(86) PCT No.: PCT/JP05/10445

§ 371 Date: Apr. 28, 2006

(30) Foreign Application Priority Data
Jun. 3, 2004 (JP) 2004-165875

(51) Int. Cl. G11B 7/00

(52) U.S. Cl. 369/275.4

(57) ABSTRACT

A method for recording and reproducing information at multiple levels comprises steps of recording an information-coding pit at one of multiple levels in each of recording domains placed successively on a track of an optical information recording medium by utilizing combination of a width in a track direction of an information-coding pit and a position in the track direction of the information-coding pit, detecting reproduced signals at two or more positions in the recording domain, and reproducing the information according to judgment of the width of the information pit by comparison of the reproduced signals with a predetermined threshold width value and judgment of the shift direction and/or shift degree by comparison with levels of the plural reproduced signals.

### TECHNICAL FIELD

The present invention relates to a method for multi-level recording and reproduction of information by information-coding pits at multiple recording levels.

### BACKGROUND ART

Lately, the optical memory industries are expanding, including CDs and DVDs for read-only, write-once recording mediums employing a thin film metal or a pigment type recording material, rewritable recording mediums employing a magneto-optical material or a phase-changeable material. The application fields are spreading to consumer uses and external memories of computers. Research and development is being made for a higher density of recording. For making finer the optical spot for recording and reproduction of information, the wavelength of the light source is being changed from a red region (650 nm) to bluish violet region (405 nm); and the numerical aperture of the objective lens is being increased from 0.6-0.65 to 0.85. On the other hand, techniques of multi-level recording and reproduction are proposed for more effective recording and reproduction without changing the light spot size.

For example, the inventors of the present invention disclosed, in Japanese Patent Application Laid-Open No. H5-128530, a recording method which records information at multiple levels by utilizing the width in the track-direction of the information-coding pit and a positional shift degree of the information-coding pit in the track direction relative to the reproduction light spot; and disclosed also a reproduction method which reproduces the multi-level information recorded in the information-coding pits by comparison of the detected signal from the light spot with preliminarily learned detection signals.

In Meeting of ISOM2003, which is an international society of research of optical disks, a report is presented on eight-level recording and reproduction by employing a bluish violet light source (405 nm), an optical system of NA 0.65, and an optical disc of a track pitch of 0.46 μm having information-coding pit recording domains having a width of 0.26 μm in the track direction (Write-once Discs for Multi-Level Optical Recording: Preprint Fr-Po-04).

The eight-levels of the information-coding pit can be provided, for example, as shown in FIG. 8 such that the width W=0.26 μm in the track direction of the information recording domain is divided into 16 equal portions (16 channel bits), wherein Level 0 portion records no information-coding pit, Level 1 portion takes 2 channel bit width, Level 2 portion takes 4 channel bit width, Level 3 portion takes 6 channel bit width, Level 4 portion takes 8 channel bit width, Level 5 portion takes 10 channel bit width, Level 6 portion takes 12 channel bit width, and Level 7 portion takes 14 channel bit width.

In the above recording, the information-coding pits are recorded at random. A light beam is projected in a spot at wavelength of 405 nm with a numerical aperture of 0.65, and the quantity of reflected light is measured by a photodetector. The reproduced signals are sampled from the multi-level information-coding pits at a timing when the light spot is brought to the center C of the width W in the track direction of the information-coding pit recording domain. Thereby the reproduced signals for the respective levels distribute as shown in FIG. 9. When domains of Level 0 are repeated in which no information-coding pit is recorded, the reproduced signal is normalized as “1”, and when domains of Level 7 are repeated, the reproduced signal is normalized as “0”.

The reproduced signal value of the respective levels has a distribution owing to influences of the adjacent information-coding pits (inter-symbol interference). When the distribution of a reproduced signal overlaps the adjacent levels as shown in FIG. 9, the signals cannot be detected separately by a fixed threshold value.

The report presented in ISOM2003 Meeting discloses a system for separate detection of a reproduced signal in which a series of an objective pit and preceding and following pits of known information-coding pit values are read and memorized (learned), and the reproduced signal from the objective information-coding pit is detected by reference to the memorized information-coding pit values (correlated). This system achieves a recording density of about 16 Gbit/inch².

With a light source of bluish purple (405 nm) and an optical system of NA 0.85 to minimize the light spot size, and with the multi-level system disclosed in ISOM2003 Meeting, a high recording density of about 30 Gbit/inch² is estimated to be achieved from light spot size ratio.

However, the multi-level system disclosed in ISOM2003 Meeting employs eight levels of pits including seven information-coding pits having the widths changed stepwise in the track direction and one no-information-coding pit. When the light spot is made smaller in the system of bluish violet light force (405 nm) and NA 0.85, the minimum pit width will be as small as 25 nm. Such a fine information-coding pit cannot readily be recorded on an optical disk.

Further, in information reproduction by the multi-level system disclosed in the ISOM2003 Meeting, the reproduction is conducted by reference to the learnt information for the purpose of eliminating the influence of the preceding and following information-coding pits (inter-symbol interference). This system requires a complicated reproducing system because the difference in the width in the track direction of the information-coding pits cannot be detected separately by reference to one fixed threshold value disadvantageously. Furthermore, in the multi-level system disclosed in the ISOM2003 Meeting, the information-coding pits are respectively recorded with the pit center positioned at the center of the information-coding pit recording domain.

### DISCLOSURE OF THE INVENTION

The present invention is made in view of such a technical background. The present invention intends to provide a method for recording and reproducing optical information at a high recording density at multiple levels without complicating the reproducing system and an apparatus therefor.

According to an aspect of the present invention, there is provided a method for recording and reproducing information at multiple levels, comprising steps of:
recording an information-coding pit at one of multiple levels in each of recording domains placed successively on a track of an optical information recording medium by utilizing combination of a width in a track direction of an information-coding pit and a position in the track direction of the information-coding pit;
detecting reproduced signals at two or more positions in the recording domain;
reproducing the information according to judgment of the width of the information pit by comparison of the reproduced signals with a predetermined threshold width value and judgment of the shift direction and/or shift degree by comparison with levels of the plural reproduced signals.

The reproduced signal is preferably detected at a time when the center of the reproducing light spot has come to the center of the width in the track direction of the information-coding pit.

Another aspect of the present invention, there is provided an apparatus for recording and reproducing information in multiple levels, comprising:
an information-recording circuit for recording an information-coding pit at one of multiple levels in each of recording domains placed successively on a track of an optical information recording medium by utilizing combination of a width in a track direction of an information-coding pit and a position in the track direction of the information-coding pit;
a detecting circuit for detecting reproduced signals at two or more positions in the recording domain;
an information reproducing circuit for reproducing the information according to judgment of the width of the information pit by comparison of the reproduced signals with a predetermined threshold width value and judgment of the shift direction and/or shift degree by comparison with levels of the plural reproduced signals.

### BRIEF DESCRIPTION OF THE DRAWINGS

FIG. 1 is a block diagram showing an embodiment of the optical information recording-reproducing apparatus of the present invention.

FIG. 2 is a drawing for explaining the widths in the track direction and recording position of the multi-level information-coding pits corresponding to the pit levels according to the present invention.

FIG. 3 shows schematically random recording of information-coding pit on a track, and a light spot projected thereon.

FIG. 4 shows distributions of reproduced signals on reproducing the information-coding pits by the recording system shown in FIG. 2.

FIG. 5 is a drawing for explaining judgment of the record positions of the information-coding pits of the present invention.

FIG. 6 is a drawing for explaining the widths in the track direction and recording position of the multi-level information-coding pits corresponding to the pit levels in another embodiment of the present invention.

FIG. 7 shows distribution of reproduced signals on reproduction of the information-coding pits by the recording system shown in FIG. 6.

FIG. 8 shows sizes of information-coding pits and recording positions in a conventional eight-level system.

FIG. 9 shows distribution of reproduced signals on reproduction of the information-coding pits by the conventional system shown in FIG. 8.

### BEST MODE FOR CARRYING OUT THE INVENTION

Best modes of the present invention are explained below by reference to drawings.

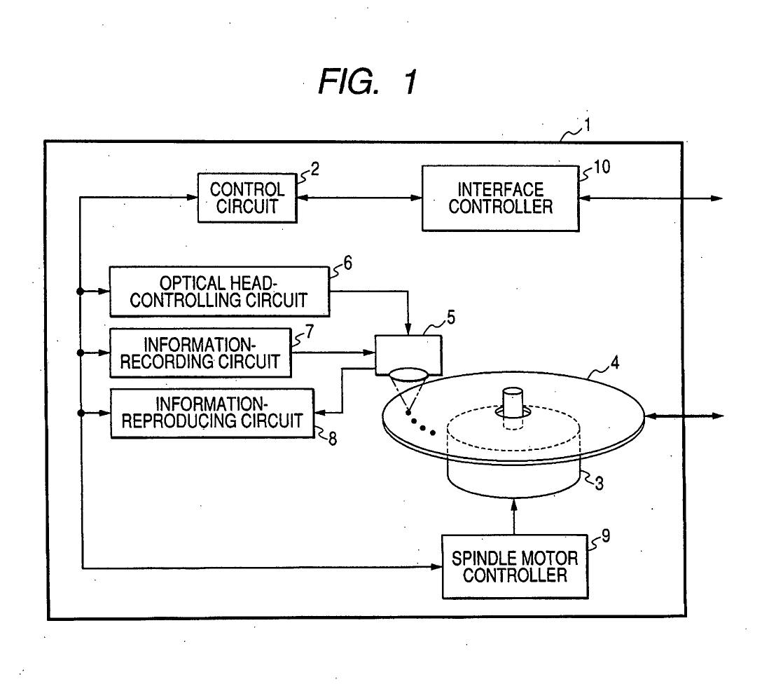

FIG. 1 is a block diagram showing an embodiment of the optical information recording-reproducing apparatus of the present invention.

In FIG. 1, optical information recording-reproducing apparatus 1 comprises control circuit 2, spindle motor 3, optical disk 4, optical head 5, optical head-controlling circuit 6, information-recording circuit 7, information-reproducing circuit 8, spindle motor controller 9, and interface controller 10. Control circuit 2 controls transmission and reception of information to or from an external information processing apparatus such as a computer, and also controls recording and reproduction of information on optical disk 4 through information recording circuit 7 and information. reproducing circuit 8, and other working units. Information recording circuit 7 records information at multiple levels, and information reproducing circuit 8 reproduces the multi-level-recorded information.

Spindle motor 3 is controlled by spindle motor controller 9 and rotates optical disk 4. Optical disk 4 is an optical information recording medium mountable onto and demountable from optical information recording-reproducing apparatus 1.

Optical head 5 records and reproduces information optically on optical disk 4. Optical head 5 which employs, for example, a light source of a wavelength λ of 405 nm and an objective lens of a numerical aperture 0.85, will give a light spot of a size 1.2(λ/NA), about 0.57 μm. The track pitch is designed to be 0.32 μm. Optical head control circuit 6 controls the position of the light spot projected from optical head 5 and controls auto-tracking, seeking, and auto-focusing.

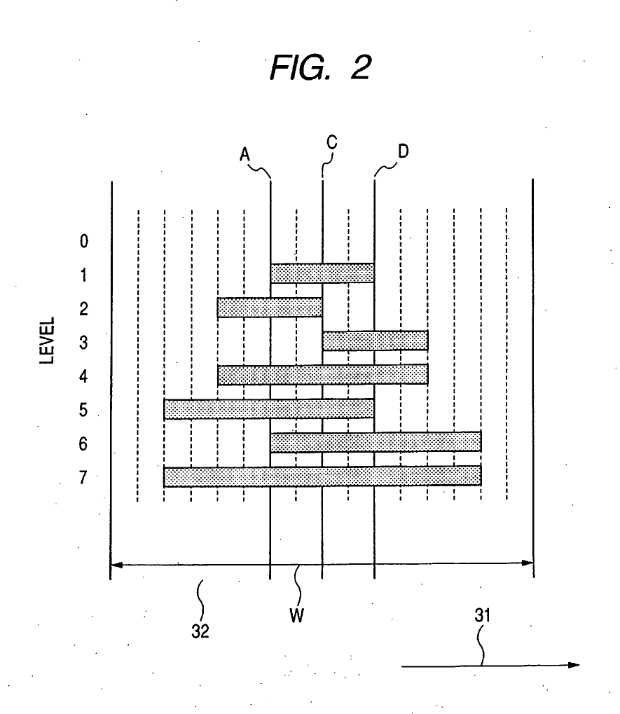

FIG. 2 is a drawing for explaining the width in the track direction and recording position of the information-coding pit corresponding to the levels of the multi-level information-coding pit in the pit-recording domain in an optical information recording-reproducing apparatus of the present invention. For convenience of explanation, the width perpendicular to the track direction of the information-coding pit is shown smaller than actual one in the drawing.

In FIG. 2, arrow mark 31 indicates the track direction. The domain 32 between the thick lines is utilized for recording an information-coding pit. Such domains for recording respectively an information-coding pit are provided in series in the track direction. In this embodiment, the size of the light spot is designed to be about 0.57 μm. When an optical disk of the track pitch of about 0.32 μm is used, an areal recording density of 30 Gbit/inch² is achievable by making the width W of the domain for an information-coding pit recording to be less than about 200 nm. Therefore, in the description below, the width of the domain for the information-coding pit recording is assumed to be 200 nm.

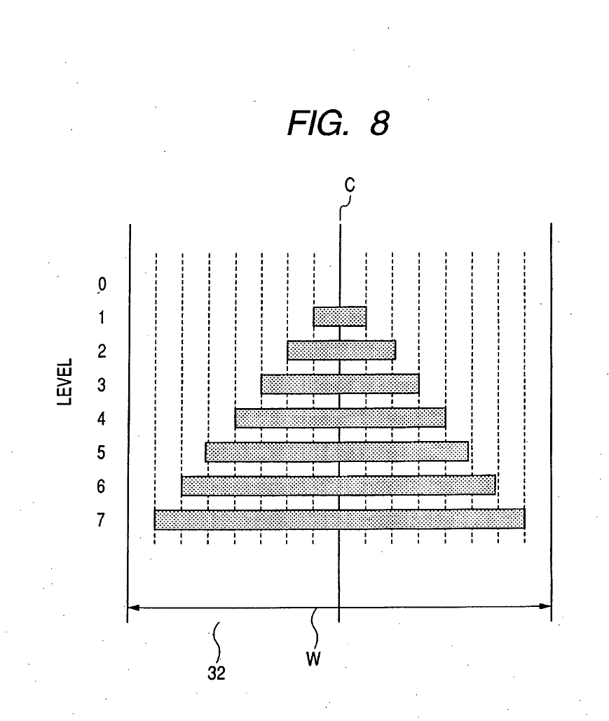

When this constitution of the optical disk is employed in a conventional method shown in FIG. 8, the smallest information-coding pit will have a width of 25 nm. This size of information-coding pit is too small for recording by a conventional method. In this embodiment of the present invention, the domain for the recording is divided into 16 divisions (16 channel bits) as shown by broken lines in FIG. 2, and three widths in the track direction of the information-coding pits are utilized: the three widths being 4(W/16), 8(W/16), and 12(W/16) where W denotes the width of the recording domain. With the width W of 200 nm, the width of the smallest information-coding pit, 4(W/16), is 50 nm, which makes easy the recording in comparison with the application of conventional methods.

Eight levels can be designed with the above three widths of the pits, for example, as below.
Level 0: No information-coding pit is recorded in the recording domain;
Level 1: Information-coding pit is recorded in a width of 4 channel bits (4(W/16)) at the center in the track direction of the recording domain;
Level 2: Information-coding pit is recorded in a width of 4 channel bits (4(W/16)) in advance from Level 1 by 2 channel bits (2(W/16)) in the track direction;
Level 3: Information-coding pit is recorded in a width of 4 channel bits (4(W/16)) with delay from Level 1 by 2 channel bits (2(W/16)) in the track direction;
Level 4: Information-coding pit is recorded in a width of 8 channel bits (8(W/16)) at the center in the track direction of the recording domain;
Level 5: Information-coding pit is recorded in a width of 8 channel bits (8(W/16) in advance from Level 4 by 2 channel bits (2(W/16)) in the track direction;
Level 6: Information-coding pit is recorded in a width of 8 channel bits (8(W/16)) with delay from Level 4 by 2 channel bits (2(W/16)) in the track direction; and
Level 7: Information-coding pit is recorded in a width of 12 channel bits (12(W/16) at the center in the track direction of the recording domain.

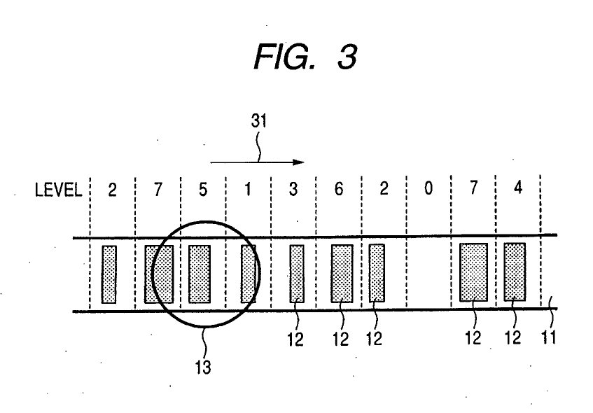

FIG. 3 shows schematically information-coding pits recorded randomly on a track, and a projected light spot. For example, when a phase changeable material is used as an erasable recording medium, plural reproduction levels of information-coding pits can be formed by changing the shape of the information-coding pit by adjusting the light quantity for recording and erasing and timing therefor in projection of a light beam onto an optical disk.

As the erasable recording medium, magnetooptical materials are also useful other than the aforementioned phase-changeable recording medium. With the magnetooptical recording medium, a magnetic field not shown in the drawing is also applied together with the light beam in the optical information recording-reproducing apparatus to change the shape of the information-coding pit to form plural reproduction levels of information-coding pits. Otherwise, a recording medium for read-only can be used. Organic materials or metal films are also useful as the recording material. With such a recording material, in projection of a light beam onto a recording domain, by adjusting the light quantity for recording and erasing and the timing therefor, the shape of the information-coding pit can be changed to form plural reproduction levels of information-coding pits. Also with a recording medium of read-only, information-coding pits can be formed in a projection-depression shape called phase pits on a substrate: multi-level of recording can be made by modifying the area or optical depth of the phase pits.

For increasing the memory capacity, the domain for recording the information-coding pit should be made smaller. With the smaller domain, two or three information-coding pits in the recording domains come to be covered by the reproduction beam spot as shown in FIG. 3. The principle of the embodiment of the present invention is explained for such a multi-level recording with a phase-changeable material as the recording material.

In FIG. 3, arrow mark 31 denotes the track direction. The numeral 11 denotes a portion (domain) of the track for recording an information-coding pit on an optical disk. The broken lines show boundaries between the domains for recording an information-coding pit. In the respective recording domains, information-coding pit 12 is recorded at an information-coding level number shown upper portion of the drawing corresponding to the levels shown in FIG. 2. The numeral 13 denotes a light spot. For improving the areal information density in comparison with conventional systems, the width (W) of the recording domain should be smaller than the size of the light spot (1.2(λ/NA)), namely W<1.2(λ/NA).

In this embodiment, the size of the light spot is about 0.57 μm, and the width of the recording domain is 200 nm (0.2 μm). In this dimensional scale, the areal information recording density can be improved by a factor of about 1.5 in comparison with conventional systems (e.g., areal-information density of 19.5 Gbit/inch² in 17-PP modulation and 2T=139 nm).

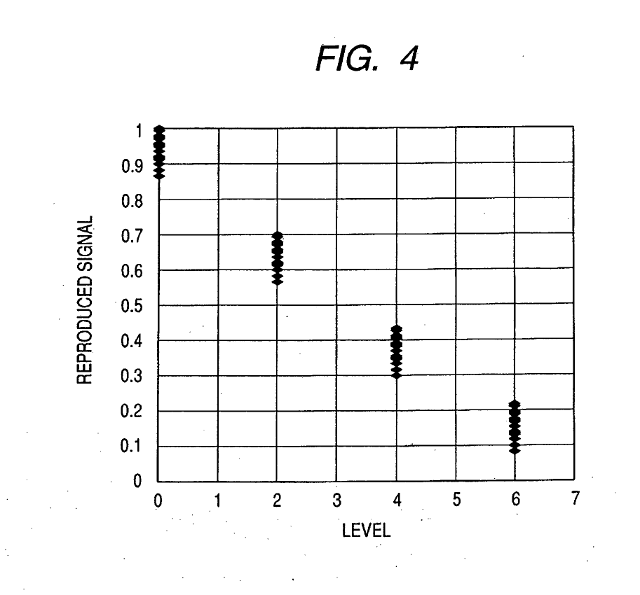

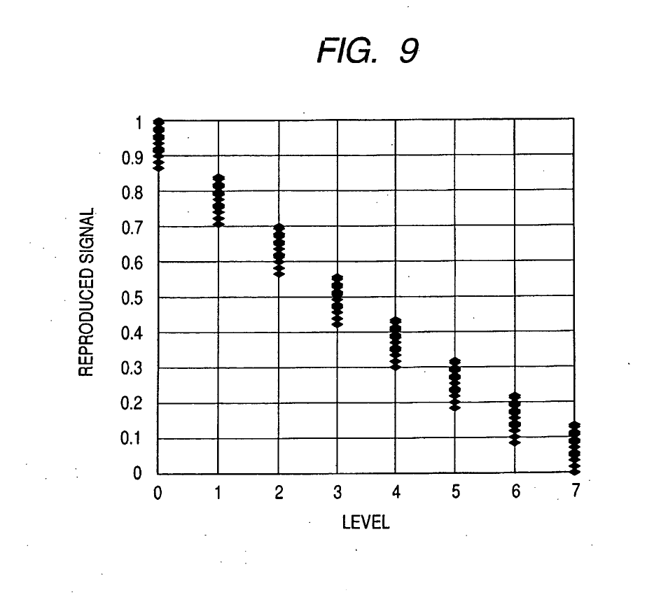

Three signals of 4(W/16), 8(W/16), and 12(W/16) selectively taken out from the distributions of reproduced signals shown in FIG. 9 can separately be detected by reference to a fixed threshold value as understood from FIG. 4.

The information-coding pits recorded on optical disk 4 are read out with a light spot. The reflected light from optical disk 4 is received by a photodetector in optical head 5. The signal detected by the photodetector is sampled at the timings when the center C of the optical spot passes the positions: the center position of the information-coding pit recording domain (this detected signal being referred to as S(center)), the position A advanced from the center by 2(W/16) (this detected signal being referred to as S(front)), and the position D delayed from the center by 2(W/16) (this detected signal being referred to as S(back)).

The width in the track direction of the recorded information-coding pit is judged from any of the detected signals of S(center), S(front), and S(back) at positions C, A and D respectively by reference to fixed thresholds. Specifically, FIG. 4 shows the relation between the information-coding level and the reproduced signal. In this embodiment, for instance, in FIG. 4, thresholds are provided at 0.8, 0.5, and 0.25 of reproduced signal. The width in the track direction of the information-coding pit is read by comparison of the reproduced signal level with the thresholds.

On the other hand, the position of the information-coding pit, namely the position at domain center, the front side of the domain center, or the back side of the domain center, is detected by the intensity of S(front) and S(back) at positions A and D, and the difference thereof.

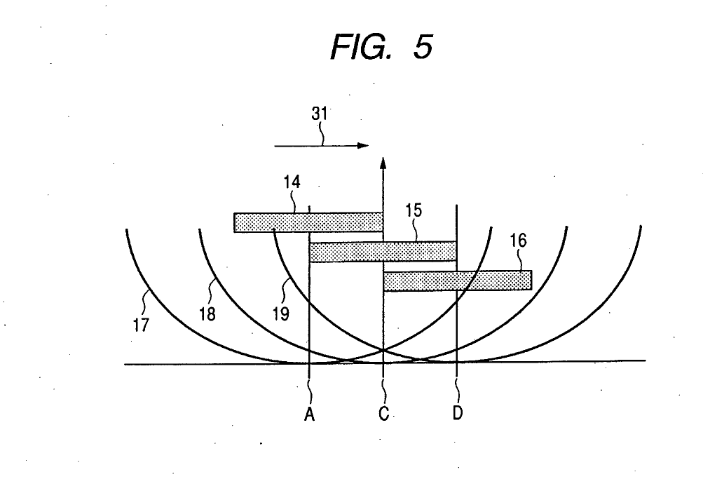

FIG. 5 shows the intensities of signals reproduced by a light spot from three isolated information-coding pits recorded at three positions, i.e. C: the center of the domain, A: the position advanced from the center by 2(W/16), and D: the position delayed from the center by 2(W/16).

In FIG. 5, numeral 31 shows the track direction; information-coding pit 14 is recorded before the center, information-coding pit 15 is recorded at the center, and information-coding pit 16 is recorded after the center of the record domain. In the drawing, the widths and positions perpendicular to the track direction of the information-coding pits are changed for convenience of explanation.

Curves 17, 18, and 19 show respectively a change curve of reproduced signal with scanning movement of the light spot: curve 17 for information-coding pit 14 recorded before the domain center, curve 18 for an information-coding pit 15 recorded at the domain center; and curve 19 for an information-coding pit 16 recorded after the domain center.

The signals are sampled from the respective signal curves, at the three positions of the light spot, i.e. A: 2(W/16) before the domain center, C: the domain center, and D: 2(W/16) after the domain center. The values of the signals are represented by S(front), S(center), and S(back).

With information-coding pit 15 recorded at the domain center C, the values of S(front) and S(back) are equal to each other and are close to S(center). In other words, the information-coding pit is judged to be recorded at the domain center when S(front) and S(back) are equal to each other and close to S(center).

With information-coding pit 14 recorded at A, 2(W/16) before the domain center, the S(front) is weak, S(center) is a little stronger, and S(back) is further stronger. In other words, the information-coding pit is judged to be recorded at the position before the domain center when the difference of S(front) and S(back) is large and S(front) is weaker than S(back).

With information-coding pit 16 recorded at D, 2(W/16) after the domain center, the S(back) is weak, S(center) is a little stronger, and S(front) is further stronger. In other words, the information-coding pit is judged to be recorded at the position before the domain center when the difference of S(front) and S(back) is large and S(front) is stronger than S(back).

In FIG. 5, the explanation is made for isolated coding pits without consideration of the interference between the coding pits. However, actually, in consideration of the interference between the information codes, the position of the information-coding pit is preferably judged by the sign of the difference between S(front) and S(back) only when the extent of the difference is larger than a certain value. The position of the information-coding pit, at the center, frontward, or backward portion: C, A or D in the domain, can also be judged by comparison of the value of S(center) with the value of S(front) or S(back).

In the system of FIG. 2 as explained above, since the differences of the widths of the information-coding pits are respectively 4 channel bits (4(W/16)), the difference of the widths can be discriminated by a fixed threshold value in reproduction of the signals. Further, the distance between the ends of the information-coding pits in their respective adjacent information-coding domains is 4 channel bits (4(W/16)) or more, so that the interference between the codes is less liable to occur.

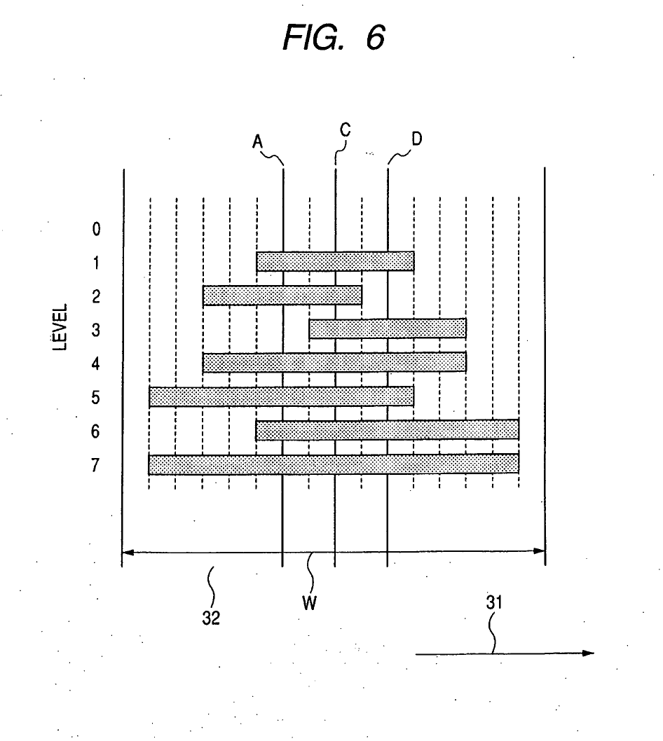

FIG. 6 is a drawing for explaining the width in the track direction and recording position of the information-coding pit corresponding to the levels of the multi-level information-coding pit in an optical information recording-reproducing apparatus of the present invention. For convenience of explanation, the width perpendicular to the track direction of the information-coding pit is shown smaller than the actual dimensional ratio, in the drawing.

In FIG. 6, arrow mark 31 indicates the track direction. The domain 32 between the thick lines is utilized for recording an information-coding pit. In this embodiment with an optical system and an optical disk similar to the ones in the previous embodiment, an areal recording density of 30 Gbit/inch² is achievable by making the width of the domain for an information-coding pit recording to be less than about 200 nm.

In this embodiment also, the domain for the recording is divided into 16 divisions (16 channel bits), and three widths in the track direction of the information-coding pits are utilized: 6(W/16), 10(W/16), and 14(W/16) where W denotes the width of the recording domain. With the width W of 200 nm, the width of the smallest information-coding pit, 6(W/16), is 75 nm, which makes easy the recording in comparison with the aforementioned embodiment.

Eight levels can be designed, for example, as below.
Level 0: No information-coding pit is recorded in the recording domain;
Level 1: Information-coding pit is recorded in a width of 6 channel bits (6(W/16)) at the center in the track direction of the recording domain;
Level 2: Information-coding pit is recorded in a width of 6 channel bits (6(W/16)) in advance from Level 1 by 2 channel bits (2(W/16)) in the track direction;
Level 3: Information-coding pit is recorded in a width of 6 channel bits (6(W/16)) with delay from Level 1 by 2 channel bits (2(W/16)) in the track direction;
Level 4: Information-coding pit is recorded in a width of 10 channel bits (10(W/16)) at the center in the track direction of the recording domain;
Level 5: Information-coding pit is recorded in a width of 10 channel bits (10(W/16)) in advance from Level 4 by 2 channel bits (2(W/16)) in the track direction;
Level 6: Information-coding pit is recorded in a width of 10 channel bits (10(W/16) with delay from Level 4 by 2 channel bits (2(W/16)) in the track direction; and
Level 7: Information-coding pit is recorded in a width of 14 channel bits (14(W/16) at the center in the track direction of the recording domain.

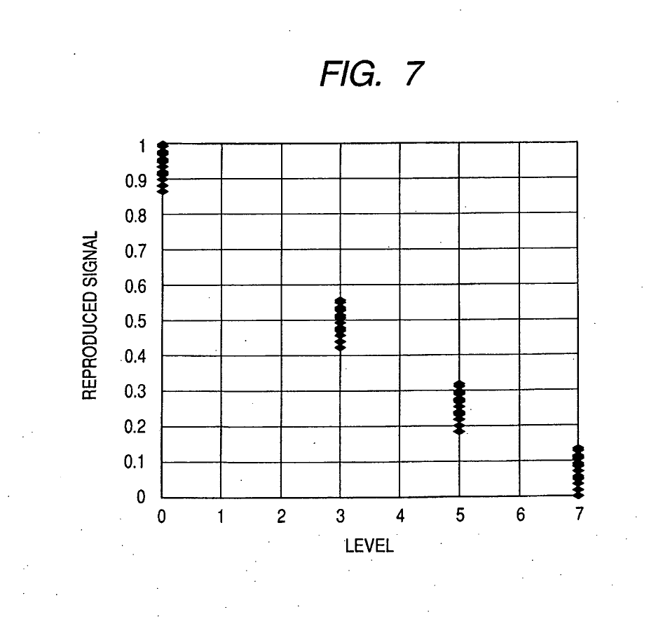

Signals of 6(W/16), 10(W/16), and 14(W/16) taken out selectively from the distribution of reproduced signals in FIG. 9 are shown as in FIG. 7. Therefore, in this embodiment also, three kinds of widths of information-coding pits can be separately detected with fixed threshold values ,e.g. 0.7, 0.35 and 0.15. The position of the information-coding pit is judged in a similar manner as explained by reference to FIG. 5. The position of the information-coding pit, at the center, frontward, or backward portion: C, A or D in the domain, can also be judged by comparison of the value of S(center) with the value of S(front) or S(back).

The above description explains the recording and reproduction with three kinds of pit width and frontward or backward shift of the information-coding pit, but it is not limited thereto. For example, the information-coding pit may be shifted forward or backward by two or more steps from the center in the domain. When the information-coding pits are recorded with multiple degrees of shift, the degree of the shift needs to be detected. The degree of the shift can be detected by the absolute value of the difference of the reproduced signals sampled.

As described above, when the information-coding pits are recorded in multiple levels of the information-coding pits, the multi-level information can be reproduced by detecting the direction and degree of the shift.

The points of the sampling of the reproduced signal are not limited to three points. The number of the sampling points may be two, or more than three provided that the width and position in the track direction of the information-coding pit can be detected.

This application claims priority from Japanese Patent Application No. 2004-165875 filed on Jun. 3, 2004, which is hereby incorporated by reference herein.

1. A method for recording and reproducing information at multiple levels, comprising steps of:
recording an information-coding pit at one of multiple levels in each of recording domains placed successively on a track of an optical information recording medium by utilizing combination of a width in a track direction of an information-coding pit and a position in the track direction of the information-coding pit;
detecting reproduced signals at two or more positions in the recording domain;
reproducing the information according to judgment of the width of the information pit by comparison of the reproduced signals with a predetermined threshold width value and judgment of the shift direction and/or shift degree by comparison with levels of the plural reproduced signals.

2. The method according to claim 1, wherein the reproduced signal is detected at a time when the center of the reproducing light spot has come to the center of the width in the track direction of the information-coding pit.

3. An apparatus for recording and reproducing information in multiple levels, comprising:
an information-recording circuit for recording an information-coding pit at one of multiple levels in each of recording domains placed successively on a track of an optical information recording medium by utilizing combination of a width in a track direction of an information-coding pit and a position in the track direction of the information-coding pit;
a detecting circuit for detecting reproduced signals at two or more positions in the recording domain;
an information reproducing circuit for reproducing the information according to judgment of the width of the information pit by comparison of the reproduced signals with a predetermined threshold width value and judgment of the shift direction and/or shift degree by comparison with levels of the plural reproduced signals.
